(19) United States
(12) Patent Application Publication
(10) Pub. No.: US 2003/0137529 A1
(43) Pub. Date: Jul. 24, 2003

(54) Method for reconstructing a surface of a workpiece

(75) Inventors: Leif Kobbelt, Aachen (DE); Wolfgang Papiernik, Neunkirchen (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/337,952

(22) Filed: Jan. 7, 2003

(30) Foreign Application Priority Data
Jan. 7, 2002 (DE) 102 00 323.8
Oct. 21, 2002 (DE) 102 48 990.4

(51) Int. Cl. G09G 5/00

(52) U.S. Cl. 345/700

(57) ABSTRACT

In a method for reconstructing a surface of a workpiece, in particular a surface of a workpiece formed by a five-axis milling process, an initial body which at least partially represents the workpiece is computed with a plane grid formed of rays. Each ray is formed based on a sequence of height intervals and subdivided into material-relevant regions.

### CROSS-REFERENCES TO RELATED APPLICATIONS

This application claims the priority of German Patent Applications, Serial Nos. 102 00 323.8, filed Jan. 7, 2002, and 102 48 990.4, filed Oct. 21, 2002, pursuant to 35 U.S.C. 119(a)-(d), the disclosure of which is incorporated herein by reference.

### BACKGROUND OF THE INVENTION

The present invention relates to a method for reconstructing a surface of a workpiece, in particular, a workpiece formed by a five-axis milling process, and a system for approximately reproducing the surface of the workpiece machine with a milling tool. The invention further relates to a computer program product for carrying out the method and to a computer programmed with the computer program product.

Such method can be applied, for example, to reconstruct or simulate, for example a surface of a workpiece machined with a milling tool. The workpiece to be machined is typically modeled using a CAD (computer aided design) system. An approximation of the actually generated surface of the workpiece is obtained by interpolating target points of a milling head in a milling process. A method for such approximation, which relates in particular to three axes milling processes, is described in commonly owned German patent application DE 100 56 143.9, the entire specification of which is expressly incorporated herein by reference. The surface to be determined is hereby approximated by a triangular grid which is constructed of a three-dimensional grid by evaluating a distance function. Formation of the triangular grid has certain disadvantages related to the algorithm, in particular the complexity of the algorithm which requires substantial computer resources. The complexity increases with the third power of the required accuracy, making the approximation method quite complex and time-consuming.

It would therefore be desirable to provide a method which can reconstruct the workpiece surface in a particularly simple manner and obviates the aforedescribed disadvantages. It is another object to provide a suitable system for carrying out the method as well as a computer program product and a computer programmed with the computer program product.

### SUMMARY OF THE INVENTION

According to one aspect of the present invention, a method is provided wherein an initial body that represents the entire workpiece or a part of the workpiece is computed from rays based on a plane grid, and wherein each ray is formed based on a sequence of height intervals and subdivided into material-relevant regions.

The invention is a based on the observation that a substantial portion of the computer resources in conventional approximation methods for surface reconstruction is consumed as a result of the subdivision of a space, such as the milling volume, into polyhedrons. It is hence a goal to simplify the set of three-dimensional polyhedrons, for example by forming a triangular grid. In particular, the computer resources required for the discretisized quantitative description of the workpiece surface should be reduced by one spatial dimension, i.e., from the cubic calculation in three-dimensional space to at least a quadratic computation. This can be achieved by using a two-dimensional approximation method instead of forming polyhedrons in three-dimensional space. A plane surface, in particular a plane grid of rays in the form of a so-called nail board, is determined and used for the surface approximation. With the nail board approximation, simple algorithms can be used to determine the intersection between rays, which speeds up the approximation. The rays (=“nails”) of the plane grid (=“board”) which together form the initial body or the workpiece surface, can be advantageously selected by associating with the corresponding ray one of the material-relevant regions “contains material” or “contains no material” based on a sequence of height intervals. It can be determined based on the value of the height intervals, which of the rays penetrates the milling material and which does not. From the totality of the material-containing rays, an envelope is formed for this surface as an approximate reproduction of the surface of the workpiece. The sought envelope can be approximated with the necessary accuracy by using the aforedescribed material-differentiating nail board structure.

Complex workpiece contours and contours with undercuts, which can occur during five axis milling, can advantageously be reconstructed by associating with the corresponding ray several material-relevant regions. It can be determined if a ray includes several material-relevant regions by determining for one or more partial regions of the corresponding ray, that these regions are either located within a milling volume and hence include milling material, or are located outside the milling volume and therefore do not include milling material. For example, for a workpiece having several cavities or openings, a single ray can be described by regions with material and regions without material. In other words, the corresponding section of the ray can be associated with an exterior element, an edge element, or an interior element/region in relation to the workpiece, in particular in relation to the milling volume. A ray section identified as an edge element then includes the workpiece contour representing the surface and hence the actual workpiece contour, and envelops the workpiece contour containing the interior element.

The starting body to be machined, i.e., the workpiece, can be implemented as a blank shaped as a cube or a sphere. The workpiece is advantageously simulated, at a predefined resolution, by rays of a plane grid having a minimum spacing. The resolution can is user-selectable, and a resolution in the micrometer range with a minimum distance between two adjacent rays of 1 μm is currently technically feasible.

In addition, the density of the so-called sample points, which are those points where the rays intersect with the workpiece surface, can strongly vary as a function of the tangential plane. The density is greatest when the rays intersect the surface perpendicularly. In other words, the density decreases as a cosine function when the rays intersect with the surface of the workpiece. To limit this effect, the surface of the workpiece is advantageously bounded by three orthogonal plane grids formed by the rays. The three orthogonal plane grids are formed by respective rays in the x-, y- and z-direction (=three “nail boards”) for approximating the workpiece surface and combined to form a three-dimensional grid. The density of the points of intersection (also referred to as sample points) with the surface (also referred to as “sample density”) is limited to the value 1/v2.

For a particularly simple, but still sufficiently accurate surface approximation, a three-dimensional approximation method is used. Advantageously, a multi-dimensional, in particular three-dimensional, adaptive grid representing the surface of the workpiece is determined based on the three orthogonal plane grids formed of the rays. This three-dimensional grid is based on a corresponding multi-dimensional data structure which hereinafter will be referred to as octree grid. In the octree structure, the surface of the unit or workpiece is formed by subdividing of a multi-dimensional space into three dimensions, thereby generating cubes. More particularly, an approximated envelope is determined for reconstructing the surface. A specific example of such an octree structure for surface approximation is described in commonly owned German patent application DE 100 54 902.0, the entire specification of which is expressly incorporated herein by reference. The size of the elements in the exterior region (elements forming the contour, also referred to as black elements) can be minimized by subdividing the elements into partial n-sided polygons, for example polyhedrons, with a predetermined fault tolerance. In a preferred embodiment, the adaptive octree grid is formed starting from an octree cell which is further subdivided into sub-octree cells if a ray of one of the grids within the octree cell exhibits a change in material. Octree cells, in particular sub-octree cells, that form exterior regions and have a predetermined minimum size, are referred to as voxels and are determined as marginal regions or marginal voxels. The marginal voxels approximately represent the surface of the corresponding body or workpiece.

For approximating the contour, the surface or contour of the dynamic workpiece is determined by using algorithms to form polyhedrons, in particular in a stepwise manner, preferably by determining the points of intersection of the edges of the octree cells with the rays of the corresponding nail board. Depending on the ray direction, the intersection with the edge of the octree cell is determined by the sequence of height intervals for one of the rays, in particular of the material-relevant regions of that ray. In this way, a continuous surface approximation can be generated and processed by a linear approximation of the steps, without the need to generate and process a complex dynamic octree structure.

The surface reconstruction (=“triangulation”) can be more accurately approximated by processing the adaptive octree grid into a polygon-shaped surface (=patch) for each octree cell based on the so-called “marching cubes algorithm”.

Advantageously, the aforedescribed method can be used for reconstructing a contour of a workpiece formed by milling paths. The surface of a milled workpiece is approximated based on the points of intersection of the rays with the contour of the milling head or milling tool, which travels along a predetermined milling path. Preferably, a system for visualizing and/or transforming a data set is provided which includes means for reconstructing a surface of a body. For example, the system for modeling the workpiece can be implemented as a CAD system, such as a programmable computer. The CAD system, in particular the associated CAD/CAM interface, can include a computer program product, for example a so-called NC (numerical control) program. Modeling of a workpiece with the CAD/CAM system results in a so-called NC parts programs, i.e., target points representing milling commands defining the center of the tool. The milling commands are typically translated into a meander-shaped or circular pattern. In addition, an NC parts program is generated during CAD modeling which is supplied to a controller with different NC control components, e.g., a compressor, an interpolator and the like. Advantageously, an area is visualized, which allows a better determination of contour flaws.

The invention advantageously provides a particularly simple and fast surface reconstruction by using rays for a linear surface approximation implemented as a plane grid. This approach reduces the complexity of the algorithms and increases the accuracy. In addition, the contour surfaces of a body can be rendered very accurately, resulting in a realistic rendition of the surfaces.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows schematically a plane grid of rays in the x- and y-direction;

FIG. 2A shows schematically the milling path of a cylindrical milling head represented by three consecutive cylinders;

FIG. 2B shows schematically a cross-section through a milling head, in particular a cylindrical milling head;

FIG. 3 shows schematically a ray that is subdivided into a sequence of height intervals; and

FIGS. 4A, 4B show an exemplary workpiece surface approximated by orthogonal grids.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

The invention will be described based on an exemplary algorithm for reconstructing a surface of a workpiece to be machined by a milling machine. The algorithm and/or the method can also be used for reconstructing of variety of other surfaces.

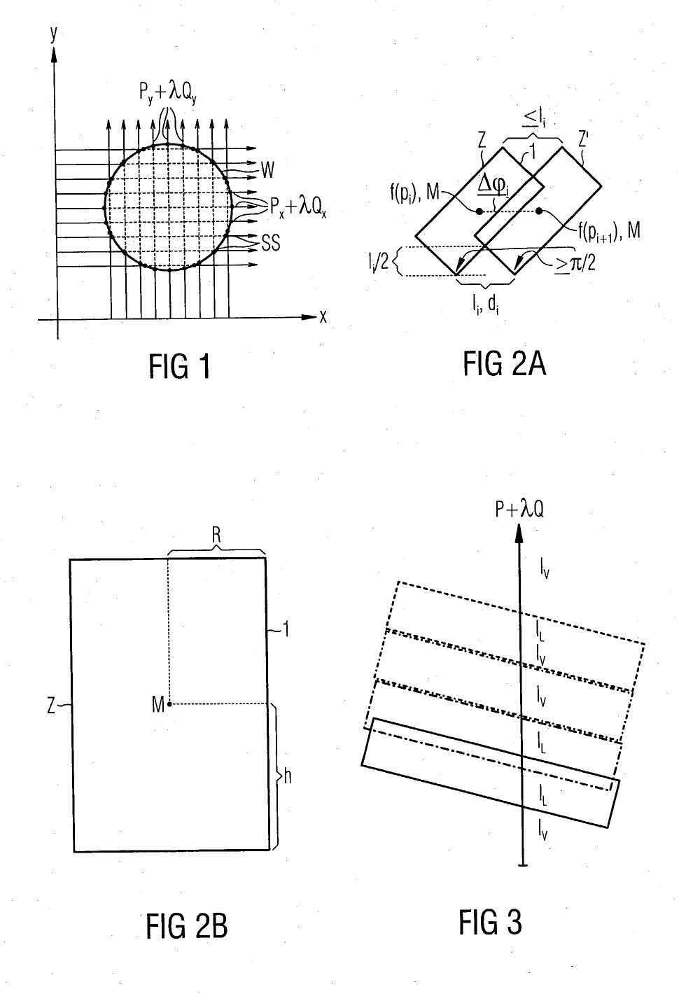

In a preferred algorithm, the geometry of the workpiece described and determined by a plane grid of rays, also referred to as nail board. More particularly, a three-dimensional grid can be formed by combining three orthogonal plane grids of rays in the x-, y- and z-direction. An adaptive octree grid is determined based on the three plane grids. FIG. 1A shows two exemplary grids of the three plane grids of rays P+λQ in the x- and y-direction. A three-dimensional grid of rays P+λQ can be described by:

$$P + λ Q = ( \begin{matrix}{P}_{x} \\ {P}_{y} \\ {P}_{z}\end{matrix} ) + λ ( \begin{matrix}{Q}_{x} \\ {Q}_{y} \\ {Q}_{z}\end{matrix} ) \qquad ( 1 )$$

A spherical workpiece W to be machined is penetrated by the rays P+λQ which form points of intersection SS with the edges of the octree cells (also referred to as ray intersecting points). In other words, the geometry of the workpiece W is described and determined based on the three-dimensional grid by a number of two-dimensional elements formed on the workpiece surface and having a predetermined number of edges. Each element forms a polyhedron.

Depending on particular method used, the surface of the body is reconstructed by an octree structure by approximating the body surface with polygons, wherein different configurations for corner points or nodes of exterior surfaces, in particular so-called edge voxels, are determined. For this purpose, distance values dᵢ are determined for the nodes f(p) and stored in table form. The eight nodes or voxel points that represent an octree grid each have a negative or non-negative value and can represent 2⁸=256 different corner or node configurations. Depending on the initial values, these configurations can be determined with a table method referred to as “Marching Cubes” (Lorensen, W. E., Cline, H. E., “Marching Cubes: A High Resolution 3-D Surface Construction Algorithm”, Computer Graphics 21 (3), 1987, p. 163-169) or with another algorithmic method.

The continuous milling volume (also referred to as “Sweep Volume”) between two target points f(pᵢ) and f(pᵢ₊₁) is determined, as depicted in FIG. 2A, by combining a set of the surface geometries for a movement of a milling head 1, e.g., a cylindrical milling head 1 formed of cylinders Z. The number of cylinders Z, Z′ depends on a distance dᵢ=f(pᵢ₊₁)−f(pᵢ) representing in the movement (with f(pᵢ₊₁), f(pᵢ)=target points, dᵢ=distance) and a rotation angle Δφᵢ between relevant orientations.

FIG. 2B shows the geometry for a milling head 1, for example a cylindrical milling head, wherein a maximum distance R from a center M or a center on the surface of the milling head 1 is preset with x²+y²=R² and z≧−h wherein x, y, z indicate the coordinate axes. The center M describes the point about which the milling head 1 with M=(0, 0, 0) rotates relative to the z-axis. A distance bᵢ resulting from a rotation of the milling head 1 about the center M with the rotation angle Δφᵢ is determined approximately according to bᵢ=r*Δφᵢ (wherein bᵢ is the distance traveled as a result of the rotation, R=radius, Δφᵢ=rotation angle). Also, a total distance Iᵢ traveled by the milling head 1 (also referred to as trajectory) is conservatively estimated according to relationship Iᵢ=dᵢ−bᵢ based on the distance bᵢ resulting from the rotation and the distance dᵢ between two target points f(pᵢ) and f(pᵢ₊₁).

A function can be defined for the corresponding body depending on the type and construction of the milling head 1, for example a sphere or a cylinder Z. As shown in FIG. 2A, the total distance Iᵢ traveled by a cylindrical milling head 1 can be described by consecutive cylinders Z and Z′. The cylinders Z, Z′ can overlap depending on a predetermined step length nᵢ. Assuming that no contour of the cylinders Z, Z′ has an acute interior angle less than π/2, an approximation error ε can be easily determined according to ε=½Iᵢ (wherein Iᵢ is the total length and ε=approximation error). Depending on a predetermined tolerance for the approximation error ε, intermediate steps with a step width nᵢ can be inserted for a defined total length Iᵢ according to nᵢ=Iᵢ/2ε−1. This interpolation takes into account both the translational and the rotational movement of the milling head 1.

Alternatively, the position and orientation can be interpolated separately, i.e., the milling head 1 is alternatingly displaced parallel to a line and then rotated. To better approximate the envelope of the workpiece W, the boundary surfaces of the milling volume can be described by bilinear surfaces F (=patches). The surface of the cylinder Z is defined by a convex tessellation. The movement (also referred to as “Sweep”) is not precisely described, but rather by an approximation of the cylinder Z with a polygon. During the movement each edge of the tessellation describes a bilinear surface F. The surface of the exact milling volume (also referred to as “sweep volume”) is approximately determined by combining several cylinders Z, Z′.

For reconstructing the workpiece surface based on the plane grid of rays P+λQ (=so-called nail board representation), each ray P+λQ is filed and stored in form of simple chained lists based on the sequence of height intervals I. Preferably, the grid is formed of rays P+λQ based on a two-dimensional field or table. The height intervals I are associated with material-relevant regions. A material-relevant region for a height interval I is for example a “containing material” region describing the height interval I_{V} through which the workpiece travels. Another material-relevant region “containing no material” describes the height interval I_{L} that extends outside the workpiece and hence does not traverse material. The following four exemplary criteria I-IV can be used to subdivide the rays P+λQ into height intervals I with I_{V} and I_{L:}

I. A new height interval I_{L} formed as an empty interval (=region containing no material) is located entirely within an existing empty interval I_{L}. The corresponding height interval I_{L} is then not changed.

II. A new empty interval I_{L} is located entirely within an existing full interval I_{L} (region “containing material”). The new height interval I_{L} is inserted in the list.

III. The new empty interval I_{L} partially overlaps an existing empty interval I_{L}. The existing empty interval I_{L} is enlarged.

IV. The new empty interval I_{L} partially overlaps several existing empty intervals I_{L}. The existing empty intervals I_{L} are combined and, if necessary, enlarged.

When reconstructing the workpiece surface, the height intervals I, I_{V} and I_{L} representing the points of intersection SS of a predetermined ray P+λQ with the volume of the removed material are determined and transmitted. It is determined for the two first configurations I and II—no change in the height intervals and/or no insertion of a new height interval—that no additional approximation steps are required, for example, by outputting a message “false”. For the configuration III and IV, a result is determined that the approximation needs to be refined by forming a so-called quad hierarchy or octree hierarchy. The quad hierarchy or octree hierarchy is based on a combination and/or a subsequent subdivision of sequences of adjacent height intervals I and their height interval boundaries.

For example, surfaces F or cylinders Z determined to be exterior regions, i.e., those elements forming the contour, are subdivided into partial n-sided polygons, i.e., partial surfaces Fₙ or partial cylinders Zₙ. Overlapping height intervals I are not combined to prevent loss of information, in particular boundary surface information.

In a preferred embodiment, the three plane grids of rays P+λQ (also referred to as two-dimensional nail boards) are generated in the x-, y-, and z-direction with a minimal sample density on the entire workpiece surface. The term sample density refers to the density of the so-called sample points that each form a point of intersection SS of the rays P+λQ with the workpiece surface. Based on a resultant three-dimensional representation of the workpiece surface, the adaptive octree grid is generated which has a maximum refinement proximate to the surface. This approach eliminates repeated calculations of points of intersection.

To decide if an octree cell [x0, x1]×[y0, y1]×[z0, z1] should be further subdivided, the height interval boundaries in the range [z0, z1] of all rays P+λQ (=nails), for example for a plane grid of rays P+λQ (=nail board) extending in z-direction, are analyzed in the range [x0, x1]×[y0, y1] to determine if the height interval boundaries are identical also for the corresponding grids of rays for the other directions x and y. The corresponding octahedral cell is subdivided if at least one point of intersection SS exists. In other words: an octahedral cell is further subdivided if a ray P+λQ of one of the orthogonal plane grids has a material change within the corresponding octahedral cell. At the finest step height, the edges of the octree cells coincide with the rays P+λQ so that very accurate surfaces can be determined and processed by using the so-called “Marching Cubes” extraction method.

The method can be used to generate an octree grid with a computer program product, for example a grid program, for reconstructing the workpiece surface, as described below.

In a first step “Data Implementation”, a data type, e.g., the plane grid of rays P+λQ (so-called nail board) is implemented which includes a field of height intervals I in the form of lists. Depending on the type and implementation of the plane grid of rays P+λQ, the individual rays P+λQ or nails can be described as height interval trees. This simplifies and accelerates the approximation process. The number of material transitions and the resulting number of height intervals I for each ray P+λQ can vary depending on the type and shape of the workpiece W to be approximated. No further optimization of the efficiency is necessary.

The approximation method is performed using the following steps:

Initialization

Insertion of a new height interval I

Interrogating a height interval I for a ray P+λQ

Interrogation for an octree cell [x0, x1]×[y0, y1]×[z0, z1]

In a second step “Calculation of Points of Intersection,” the point of intersection SS of the rays P+λQ that are substantially parallel to the axes with the volume swept by the milling tool or milling head 1 is computed using the cylinder Z. The nail board architecture is analyzed and tested based on the paths of the rays P+λQ and the milling tool geometry. Several solution trials are compared. For example, the ray coherence is utilized, i.e., the rays P+λQ are “coherent,” i.e., are essentially mutually parallel and uniformly spaced.

In a third step “Verification”, a simple visualization tool is implemented which can be used to visualize the approximated workpiece surface. The functions of the modules of the first and second step—“Data Implementation” and “Calculation of Points of Intersection”—are verified and supplied to a fourth step “Polyhedron Generation”. During the Polyhedron Generation an adaptive octree grid is determined. For this purpose, a data type octree is defined and stored as a tree structure. A resolution granularity can be predefined as a criterion for increasing the resolution of the tree structure and hence of the octree structure. Alternatively, already stored information relating to the nail board structure, such as the direction vector λQ, can be taken into account.

In a fifth step “Marching Cubes Algorithm,” the distance values dᵢ at grid points of the adaptive octahedron can be defined and set based on the table method reflecting the “Marching Cubes” so that the points of intersection SS can be determined with the greatest possible accuracy. The workpiece surface is then reconstructed based on the determined data for a given geometry of a workpiece W and a milling head 1, for example for a defined five-axes milling process, with milling instructions and a predetermined approximation tolerance provided as NC data. An approximate envelope is determined with the process steps 1 to 5 based on the bilinear surfaces F or cylinders Z, Z′.

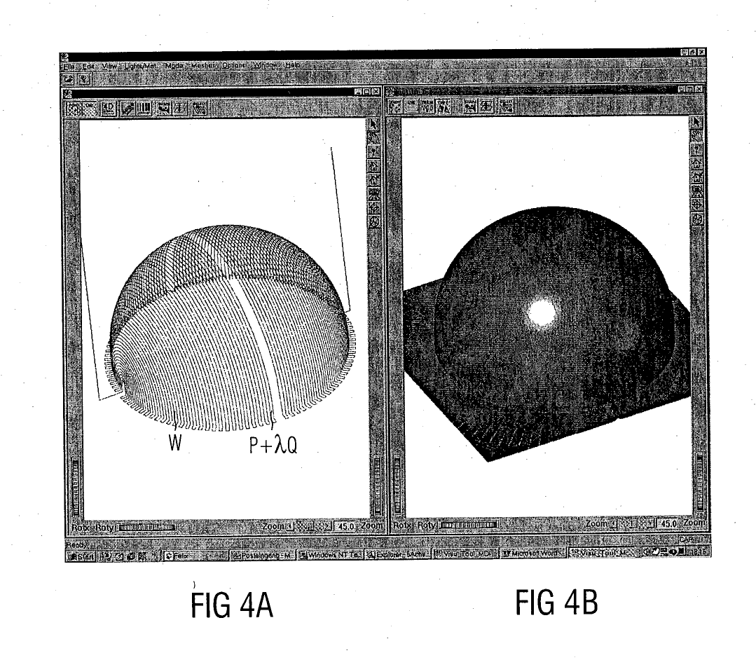

FIGS. 4 and 4B show an exemplary visualization of a workpiece surface generated with the grid or nail board approximation for a hemisphere having a diameter of 200 mm. FIG. 4A depicts the 125,000 positions and orientations that were determined with the aforedescribed method and are to be addressed by the milling head 1 during the milling operation of the workpiece W. The end face of the hemisphere forming the workpiece W is virtually machined in the visualization with a cylindrical milling head 1 having a diameter of 12 mm. The resulting machined workpiece W is depicted in FIG. 4B. The simulation time with the specified nail board resolution of 256 is 400 s. Conversely, processing the same simulation in real time with an interpolation clock cycle of 4 ms with 125,000 positions takes 500 s.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for reconstructing a surface of a workpiece, in particular a surface formed with a five-axes milling process, comprising the steps of:
defining a plane grid composed of rays; and
computing with the plane grid an initial body which at least partially represents the workpiece;
wherein each ray comprises a sequence of height intervals, said height intervals subdividing each ray into material-relevant regions.

2. The method of claim 1, wherein material-relevant region is associated with a region “containing material” or with a region “containing no material”.

3. The method of claim 1, wherein a plurality of material-relevant regions is associated with a ray.

4. The method of claim 1, wherein three orthogonal plane grids of rays are defined and the surface of the workpiece is generated based on three orthogonal plane grids of rays.

5. The method of claim 4, wherein the three orthogonal plane grids of rays are used to determine an adaptive octree grid representing the surface of the workpiece.

6. The method of claim 5, and further comprising defining an octree cell forming an element of the adaptive octree grid, wherein the octree cell is further subdivided if a ray of one of the plane grids experiences a material change inside the octree cell.

7. The method of claim 5, and further comprising defining an octree cell forming an element of the adaptive octree grid, wherein a point of intersection between one of the rays of one of the plane grids and one of the edges of the octree cell is determined based on the sequence of the height intervals.

8. The method of claim 5, wherein the adaptive octree grid is processed based on the “Marching Cubes Algorithm” to form a polygonal surface for each octree cell.

9. System for visualizing and/or transforming a data set having means for carrying out the method steps of claim 1.

10. Computer program product for carrying out the method steps of claim 1.

11. A computer programmed with the computer program product of claim 10.
